(19) United States
(12) Patent Application Publication
(10) Pub. No.: US 2023/0271360 A1
(43) Pub. Date: Aug. 31, 2023

(54) VERTICAL INJECTION MOLDING MACHINE, INJECTION MOLDING MACHINE SYSTEM, AND METHOD FOR MOLDING MOLDED ARTICLE

(71) Applicant: THE JAPAN STEEL WORKS, LTD., Tokyo (JP)

(72) Inventors: Kiyotaka NAKAYAMA, Tokyo (JP); Motohiro Morisaki, Tokyo (JP)

(73) Assignee: THE JAPAN STEEL WORKS, LTD., Tokyo (JP)

(21) Appl. No.: 18/097,685

(22) Filed: Jan. 17, 2023

(30) Foreign Application Priority Data
Feb. 25, 2022 (JP) 2022-027561

(51) Int. Cl. B29C 45/06; B29C 45/04; B29C 45/64

(52) U.S. Cl. CPC B29C 45/06; B29C 45/0408; B29C 45/641

(57) ABSTRACT

A vertical injection molding machine includes a mold clamping device configured to clamp a mold and an injection device configured to inject an injection material. The mold clamping device includes a fixed plate, an upper movable plate that is driven up and down with respect to the fixed plate, and a turntable provided on the fixed plate and is rotatable with respect to the fixed plate. In a case the turntable is provided with a plurality of types of molds configured to mold different molded articles, when the turntable is rotated, one type of the molds is switched to a molding target mold and the other type of the molds is switched to a standby target mold, and the molding target mold is clamped by driving of the upper movable plate and is injected with the injection material.

### CROSS-REFERENCE TO RELATED APPLICATIONS

This application is based on and claims priority under 35 USC 119 from Japanese Patent Application No. 2022-027561 filed on Feb. 25, 2022, the contents of which are incorporated herein by reference.

### TECHNICAL FIELD

The present disclosure relates to a vertical injection molding machine including a mold clamping device that includes a turntable and an injection device, an injection molding machine system including such a vertical injection molding machine, and a method for molding a molded article implemented by the vertical injection molding machine.

### BACKGROUND

A vertical injection molding machine includes a mold clamping device that opens and closes a mold in an up-down direction, and an injection device provided on the mold clamping device, as disclosed in JP2017-205877A, for example. The mold clamping device includes a fixed plate fixed to a frame, an upper movable plate provided above the fixed plate, and a lower movable plate provided below the fixed plate. The upper movable plate and the lower movable plate are connected by a plurality of tie bars, and a mold clamping mechanism such as a toggle mechanism is provided between the lower movable plate and the fixed plate. A turntable is provided on the fixed plate so as to be freely reversible. One upper mold is attached to the upper movable plate, and one or a plurality of lower molds are attached to the turntable. One of the lower mold is aligned with the upper mold according to a rotational position of the turntable. When the mold clamping device is driven to perform mold-clamping and an injection material is injected from the injection device, a molded article is molded.

### SUMMARY

A plurality of lower molds can be provided on the turntable, and any one of the lower molds can be aligned with the upper mold according to the rotational position of the turntable, and a molded article can be molded by clamping the molds. Therefore, if molding is performed while the turntable is rotated and the lower mold is replaced, the same type of molded article can be efficiently molded. However, problems to be solved are also found. Specifically, productivity may be low when high-mix low-volume production is implemented. That is, in order to mold different types of molded articles, it is necessary to remove the molds attached to the upper movable plate and the turntable and to attach molds corresponding to a molded article to be molded next. Such setup takes time. Therefore, productivity may be reduced.

The present disclosure provides a vertical injection molding machine capable of implementing high-mix low-volume production with high productivity, an injection molding machine system including such a vertical injection molding machine, and a method for molding a molded article.

Other problems and novel features will become apparent from the description of this specification and the accompanying drawings.

The present disclosure is directed to a vertical injection molding machine including a mold clamping device and an injection device. The mold clamping device includes a fixed plate, an upper movable plate driven up and down with respect to the fixed plate, and a turntable rotatably provided on the fixed plate. The turntable is provided with a plurality of types of molds configured to mold different molded articles. When the turntable is rotated, one type of the molds is switched to a molding target mold, and the other type of the molds is switched to a standby target mold. The molding target mold is clamped by driving of the upper movable plate and is injected with an injection material.

The present disclosure discloses the vertical injection molding machine that can implement high-mix low-volume production with high productivity.

### BRIEF DESCRIPTION OF DRAWINGS

FIG. 1 is a front view showing a vertical injection molding machine according to an illustrative embodiment.

FIGS. 2A to 2D are top views showing a turntable, an upper movable plate, and a plurality of molds provided on the turntable and the upper movable plate of the vertical injection molding machine according to the present illustrative embodiment.

FIGS. 3A and 3B are top views showing the turntable, the upper movable plate, and a plurality of molds provided on the turntable and the upper movable plate of the vertical injection molding machine according to the present illustrative embodiment.

FIG. 4 is a top view showing an injection molding machine system according to the present illustrative embodiment.

### DETAILED DESCRIPTION

Hereinafter, specific illustrative embodiments will be described in detail with reference to the drawings. However, the present disclosure is not limited to the following illustrative embodiments. For clarity of explanation, the following description and drawings are simplified as appropriate. In the drawings, the same elements are denoted by the same reference numerals, and repeated description thereof is omitted as necessary. In addition, hatching may be omitted to avoid complicating the drawings.

The present illustrative embodiment will be described.

{Vertical Injection Molding Machine}

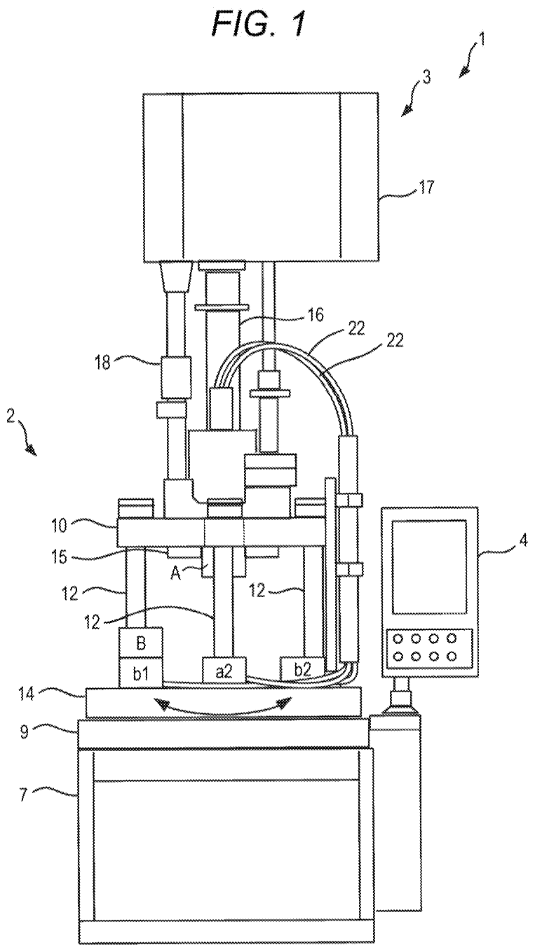

As shown in FIG. 1, a vertical injection molding machine 1 according to the present illustrative embodiment includes a mold clamping device 2, an injection device 3 provided above the mold clamping device 2, and a controller 4 configured to control the mold clamping device 2 and the injection device 3. FIG. 1 shows the vertical injection molding machine 1 as viewed from a front side, that is, an operation side.

{Mold Clamping Device}

The mold clamping device 2 includes a fixed plate 9 fixed to a housing 7, an upper movable plate 10 provided above the fixed plate 9, and a lower movable plate (not shown) provided in the housing 7. The upper movable plate 10 and the lower movable plate are connected by three tie bars 12, 12, . . . . When a mold clamping mechanism (not shown) provided between the lower movable plate and the fixed plate 9 is driven, the upper movable plate 10 is driven up and down. A turntable 14 is provided on the fixed plate 9 of such a mold clamping device 2. The turntable 14 is rotatable by a large angle of 270 degrees to 360 degrees about one tie bar 12 located at the center.

{Injection Device}

The injection device 3 is provided above the upper movable plate 10 of the mold clamping device 2. The injection device 3 includes a heating cylinder 16, a screw (not shown) provided in the heating cylinder 16, a driving mechanism 17 configured to drive the screw, and a lifting-lowering device 18 configured to lift and lower the entire injection device 3. The injection device 3 rotates the screw, melts an injection material, and drives the screw in an axial direction so as to inject the injection material.

{Mold}

In the present illustrative embodiment, the mold clamping device 2 is provided with two types of molds A, B, a2, b1, and the like to mold two types of molded articles. First, the upper movable plate 10 is provided with the upper mold A of a first type. A plurality of molds are provided on the turntable 14. The lower mold a2 of the first type, the lower molds b1 and b2 of a second type, and the upper mold B of the second type placed on the lower mold b1 of the second type are shown in FIG. 1.

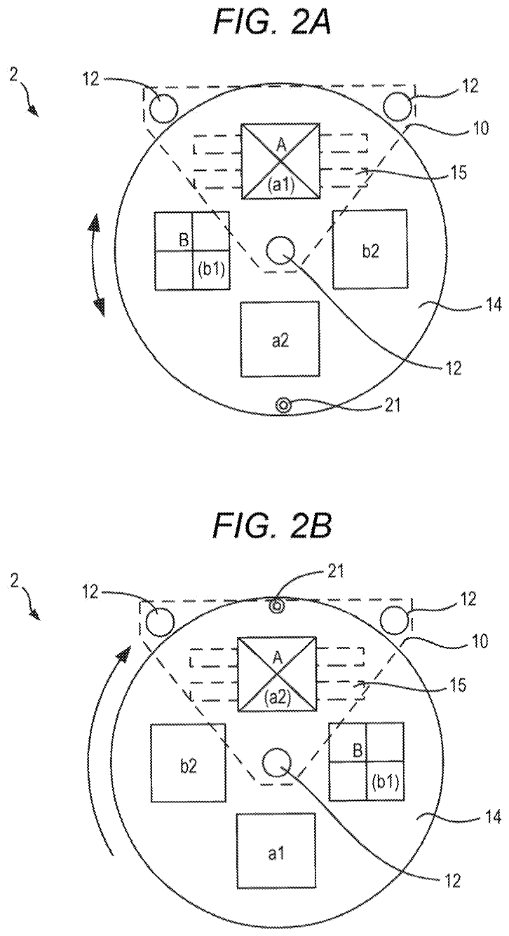

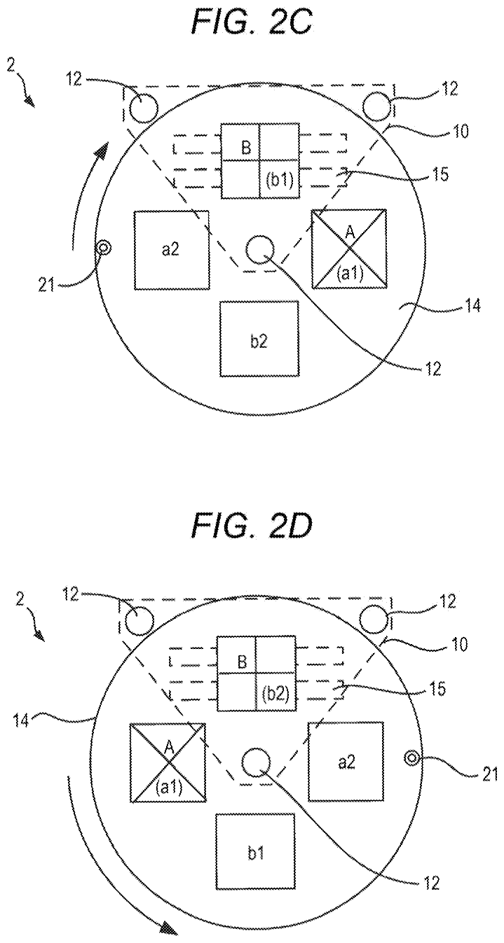

FIG. 2A shows a state in which the turntable 14 is viewed from above. In FIG. 2A, the upper movable plate 10 is shown by a dotted line. Although no marker is actually provided on the turntable 14, a virtual marker 21 is marked on the operation side, that is, on a lower side in FIG. 2A. When the marker 21 is located on the operation side, it is assumed that the turntable 14 is located at a reference rotational position. The plurality of molds are as follows. First, the upper movable plate 10 is provided with the upper mold A of a first type. When the turntable 14 is located at the reference rotational position, the lower mold a1 of the first type is provided on an anti-operation side of the turntable 14, and is aligned with the upper mold A of the first type. Therefore, in FIG. 2A, the upper mold A of the first type and the lower mold a1 of the first type are shown in an overlapped state. Since the lower mold a1 of the first type cannot be visually recognized in FIG. 2A, the lower mold a1 is denoted by “(a1)” in parentheses. The lower mold a2 of the first type is provided on the operation side of the turntable 14.

The lower mold b1 of the second type is provided at a position rotated clockwise by 90 degrees from the operation side of the turntable 14, that is, at a position on a left side in FIG. 2A, and the upper mold B of the second type is placed on the lower mold b1 of the second type. That is, the lower mold b1 of the second type cannot be visually recognized in FIG. 2A, and thus is denoted by “(b1)” in parentheses. The upper mold B of the second type is attached to and detached from the upper movable plate 10 as necessary. Incidentally, the upper mold B of the second type is not attached to the upper movable plate 10 in the state shown in FIG. 2A. The lower mold b2 of the second type is provided at a position rotated counterclockwise by 90 degrees from the operation side of the turntable 14, that is, at a position on a right side in FIG. 2A.

{Clamper}

In the present illustrative embodiment, the mold clamping device 2 is provided with a device configured to clamp and unclamp the upper molds A and B of the first and second types. That is, as shown in FIG. 1, a clamper 15 is provided in the upper movable plate 10. The clamper 15 is controlled by the controller 4. FIGS. 1 and 2A show a state in which the upper mold A of the first type is clamped by the clamper 15.

{Temperature Adjustment of Molds}

The molds A, B, a1, b1, and the like according to the present illustrative embodiment are supplied with a heat medium from a temperature adjustment device (not shown) such that temperatures thereof are adjusted. Therefore, as shown in FIG. 1, heat medium supply pipes 22, 22 are connected to the respective molds a1, b1, and the like. The heat medium supply pipes 22 are configured to supply the heat medium. Incidentally, the heat medium supply pipes 22, 22 are not shown in FIG. 2A in order to avoid complicating the drawing. The supply of the heat medium is controlled by the controller 4 (see FIG. 1).

{Molding Method According to Illustrative Embodiment}

A method for molding a molded article according to the present illustrative embodiment is a method of efficiently molding two types of molded articles in one vertical injection molding machine 1. That is, the method is a molding method that can efficiently implement high-mix low-volume production. The molding method will be described.

{Molding of Molded Article of First Type}

First, a method for molding a molded article of a first type will be described. The molded article of the first type is molded by the upper mold A of the first type and the lower molds a1 and a2 of the first type. That is, the upper mold A of the first type and the lower molds a1 and a2 of the first type are molding target molds. On the other hand, the upper mold B of the second type and the lower molds b1 and b2 of the second type are standby target molds.

As shown in FIG. 2A, a state in which the turntable 14 is located at the reference rotational position will be described. The mold clamping device 2 is driven to clamp the upper mold A of the first type and the lower mold a1 of the first type. An injection material is injected from the injection device 3 (see FIG. 1) to mold the molded article of the first type. After the injection material is solidified, the molds are opened. Then, the molded article of the first type is left in the lower mold a1 of the first type. The turntable 14 is inverted by 180 degrees from the reference rotational position. Then, as shown in FIG. 2B, the lower mold a1 of the first type is moved to the operation side. Although not shown, the molded article of the first type left in the lower mold a1 of the first type is taken out.

When the turntable 14 is located at this rotational position, the upper mold A of the first type and the lower mold a2 of the first type are aligned with each other. The mold clamping device 2 is driven to clamp the upper mold A of the first type and the lower mold a2 of the first type, and the injection material is injected from the injection device 3 (see FIG. 1) to mold the molded article of the first type. When the molds are opened after the injection material is solidified, the molded article of the first type is left in the lower mold a2 of the first type. The turntable 14 is rotated to the reference rotational position. Then, as shown in FIG. 2A, the lower mold a2 of the first type is moved to the operation side. Although not shown, the molded article of the first type left in the lower mold a2 of the first type is taken out. Thereafter, the molded article of the first type can be molded in the same manner.

{Switching of Molds}

A method for switching a molding target from the molded article of the first type to a molded article of the second type in the vertical injection molding machine 1 (see FIG. 1) will be described. During molding of the molded article of the first type, the heat medium is supplied to the lower molds b1 and b2 of the second type from several cycles before the switching is implemented. That is, a so-called pre-temperature adjustment, in which the temperatures of the lower molds b1 and b2 of the second type are adjusted in advance, is performed. The upper mold B of the second type is placed on the lower mold b1 of the second type. Therefore, heat from the lower mold b1 of the second type is also conducted to the upper mold B of the second type, and the upper mold B of the second type is subjected to the pre-temperature adjustment.

The molding target mold and the standby target mold are interchanged. First, the mold clamping device 2 is closed in the state shown in FIG. 2A, that is, in the state in which the turntable 14 is located at the reference rotational position. That is, the upper mold A of the first type is placed on the lower mold a1 of the first type. The clamper 15 is driven to unclamp the upper mold A of the first type. The mold clamping device 2 is opened. The upper mold A of the first type is maintained in a state of being placed on the lower mold a1 of the first type.

The turntable 14 is rotated clockwise by 90 degrees. Then, as shown in FIG. 2C, the lower mold b1 of the second type and the upper mold B of the second type are aligned with the upper movable plate 10. The mold clamping device 2 is closed. Next, the clamper 15 is driven to clamp the upper mold B of the second type. The switching of the molds is completed. Accordingly, the upper mold B of the second type and the lower molds b1 and b2 of the second type become molding target molds, and the upper mold A of the first type and the lower molds a1 and a2 of the first type become standby target molds. Since the lower molds b1 and b2 of the second type are subjected to the pre-temperature adjustment to have an appropriate temperature, the process can be quickly shifted to molding of the molded article of the second type.

{Molding of Molded Article of Second Type}

In a case the turntable 14 is located at a rotational position shown in FIG. 2C, the mold clamping device 2 is driven to clamp the upper mold B of the second type and the lower mold b1 of the second type. The injection material is injected from the injection device 3 (see FIG. 1) to mold the molded article of the second type. After the injection material is solidified, the molds are opened. Then, the molded article of the second type is left in the lower mold b1 of the second type. The turntable 14 is reversed by 180 degrees from this rotational position. Then, as shown in FIG. 2D, the lower mold b1 of the second type is moved to the operation side. Although not shown, the molded article of the second type left in the lower mold b1 of the second type is taken out.

When the turntable 14 is located at this rotational position, the upper mold B of the second type and the lower mold b2 of the second type are aligned with each other. The mold clamping device 2 is driven to clamp the upper mold B of the second type and the lower mold b2 of the second type, and the injection material is injected from the injection device 3 (see FIG. 1) to mold the molded article of the second type. When the molds are opened after the injection material is solidified, the molded article of the second type is left in the lower mold b2 of the second type. The turntable 14 is reversed by 180 degrees. Then, as shown in FIG. 2C, the lower mold b2 of the second type is moved to the operation side. Although not shown, the molded article of the second type left in the lower mold b2 of the second type is taken out. Thereafter, the molded article of the second type can be molded in the same manner.

In a case the molding target is switched from the molded article of the second type to the molded article of the first type, the lower molds a1 and a2 of the first type are subjected to the pre-temperature adjustment several cycles before the switching. When the molds are switched, the molds are opened and closed by the mold clamping device 2, the turntable 14 is rotated, and the clamper 15 is appropriately driven to unclamp the upper mold B of the second type and clamp the upper mold A of the first type.

### Second Illustrative Embodiment

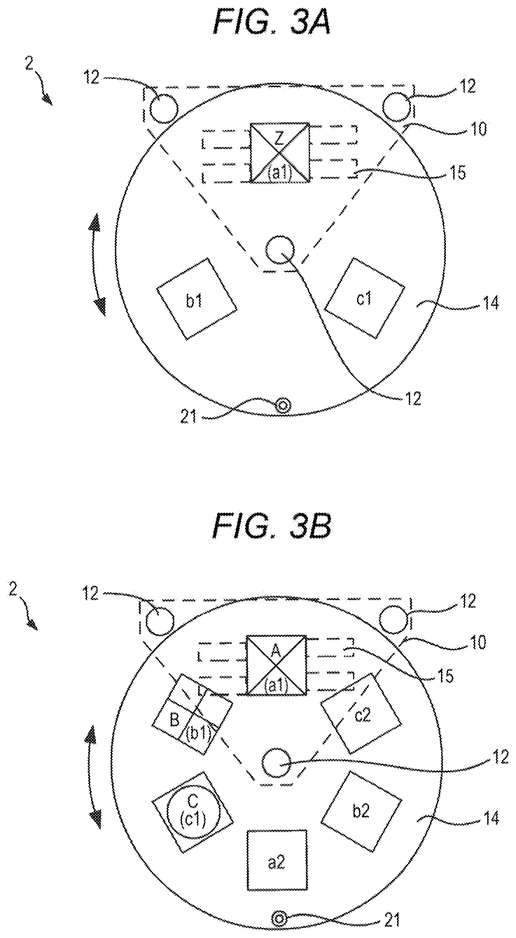

The present illustrative embodiment can be variously modified. FIG. 3A shows a state in which the lower mold a1 of the first type, the lower mold b1 of the second type, and a lower mold c1 of a third type are provided on the turntable 14 so as to be separated from each other by 120 degrees, respectively. A common upper mold Z is clamped to the upper movable plate 10 by the clamper 15. Although not shown in the drawings, the lower molds a1, b1, and c1 are different from each other in shapes or in depths of recesses (e.g., cavities) configured to mold molded articles. That is, the lower molds a1, b1, and c1 are molds configured to mold different types of molded articles. Each of the lower molds a1, b1, and c1 are opened and closed with respect to the common upper mold Z, respectively.

In a case the molded article of the first type is molded in this illustrative embodiment, the turntable 14 is rotated to be in the state shown in FIG. 3A, and the lower mold a1 of the first type and the common upper mold Z are clamped. The injection material is injected from the injection device 3 (see FIG. 1) to mold the first molded article. When the molds are opened, the molded article of the first type is left in the lower mold a1 of the first type. Although not shown, when the turntable 14 is reversed by 180 degrees, the lower mold a1 of the first type moves to the operation side. When the molded article of the first type is taken out and the turntable 14 is reversed, the state shown in FIG. 3A is restored. Thereafter, the molded article of the first type can be molded in the same manner.

In a case the molding target is switched from the molded article of the first type to the molded article of the second type or to the molded article of the third type, the heat medium is supplied to the lower mold b1 of the second type or the lower mold c1 of the third type from several cycles before the switching so as to perform the pre-temperature adjustment. When the turntable 14 is rotated by 120 degrees or 240 degrees, the common upper mold Z can be aligned with the lower mold b1 of the second type or the lower mold c1 of the third type. The molded article of the second type or the molded article of the third type can be molded in the same manner as the molded article of the first type.

### Third Illustrative Embodiment

The turntable 14 may also be provided with five or more molds. FIG. 3B shows a state in which six molds are provided. That is, the lower molds a1 and a2 of the first type, the lower molds b1 and b2 of the second type, and lower molds c1 and c2 of the third type are provided. In the state shown in FIG. 31, the upper mold A of the first type is clamped to the upper movable plate 10 by the clamper 15, and the upper mold B of the second type and an upper mold C of the third type are placed on the lower mold b1 of the second type and the lower mold c2 of the third type, respectively. The molded article of the first type, the molded article of the second type, and the molded article of the third type can be molded in this third illustrative embodiment, description of which is omitted since it is easily understood by those skilled in the art. Implementation of the pre-temperature adjustment prior to the switching of the molds makes it possible to start molding immediately after the switching of the mold.

{Injection Molding Machine System}

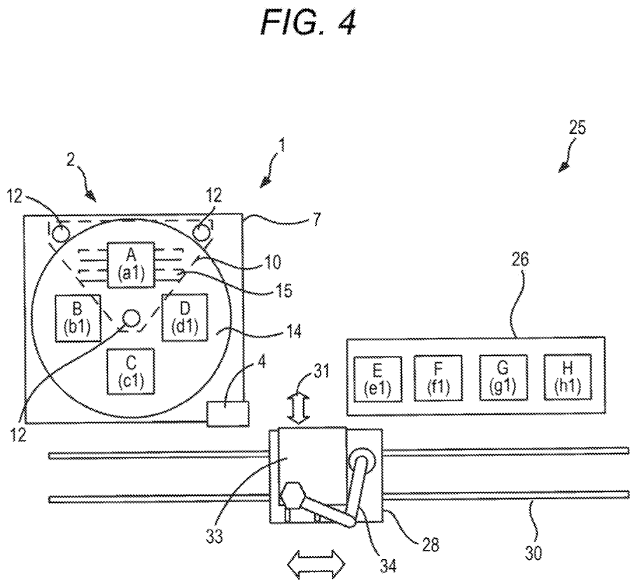

FIG. 4 further shows an injection molding machine system 25 that can implement high-mix low-volume production by using a plurality of types of molds. The injection molding machine system 25 includes the vertical injection molding machine 1 according to the present illustrative embodiment, an automatic mold warehouse 26 configured to store a plurality of types of molds E, F, G, and H, and a mold conveying carriage 28 configured to convey the molds. The mold conveying carriage 28 travels between the automatic mold warehouse 26 and the vertical injection molding machine 1 along a track 30 installed on a floor surface. The mold conveying carriage 28 is provided with a table 33 on which a mold can be placed and which can be slid in a direction of an arrow 31, and a robot arm 34.

In the injection molding machine system 25, the mold conveying carriage 28 is configured to take out the molds A, B, and the like from the vertical injection molding machine 1 and convey the molds A, B, and the like to the automatic mold warehouse 26 by using the table 33 and the robot arm 34; the mold conveying carriage 28 is configured to take out the molds E, F, and the like from the automatic mold warehouse 26 and convey the molds E, F. and the like to the vertical injection molding machine 1. Accordingly, there is substantially no limitation on the number of types of molded articles that can be molded in one vertical injection molding machine 1. Thus, high-mix low-volume production can easily be implemented.

Although the invention made by the present inventors is specifically described based on the illustrative embodiments, it is needless to say that the present invention is not limited to the illustrative embodiments described above, and various modifications can be made without departing from the scope of the invention. A plurality of examples described above may be implemented in combination as appropriate.

What is claimed is:

1. A vertical injection molding machine comprising:
a mold clamping device configured to clamp a mold; and
an injection device configured to inject an injection material,
wherein the mold clamping device comprises:
a fixed plate;
an upper movable plate that is disposed above the fixed plate and is driven up and down with respect to the fixed plate; and
a turntable provided on the fixed plate so as to be rotatable with respect to the fixed plate,
wherein the injection device is provided above the upper movable plate, and
wherein in a case the turntable is provided with a plurality of types of molds configured to mold different molded articles, when the turntable is rotated, one type of the molds is switched to a molding target mold and the other type of the molds is switched to a standby target mold, and the molding target mold is clamped by driving of the upper movable plate and is injected with the injection material.

2. The vertical injection molding machine according to claim 1, wherein when one type of mold selected from the other types of the molds is switched to the molding target mold, temperature of the selected one type of mold is adjusted in advance.

3. The vertical injection molding machine according to claim 1, wherein the upper movable plate comprises a clamper configured to clamp and unclamp an upper mold of the molding target mold.

4. An injection molding machine system comprising:
the vertical injection molding machine according to claim 1;
an automatic mold warehouse configured to store the plurality of types of molds; and
a mold conveying device configured to convey the mold,
wherein the molds are exchanged between the vertical injection molding machine and the automatic mold warehouse by the mold conveying device.

5. A method for molding a plurality of types of molded articles in a vertical injection molding machine,
the vertical injection molding machine comprising:
a mold clamping device configured to clamp a mold; and
an injection device configured to inject an injection material,
the mold clamping device comprising:
a fixed plate;
an upper movable plate that is disposed above the fixed plate and is driven up and down with respect to the fixed plate; and
a turntable provided on the fixed plate so as to be rotatable with respect to the fixed plate, and
the injection device being provided above the upper movable plate,
in a case the turntable is provided with a plurality of types of molds configured to mold different molded articles, when one type of the molds, which is to be clamped by driving of the upper movable plate and injected with the injection material to mold a molded article, is set as a molding target mold and the other type of the molds is set as a standby target mold from among the plurality of types of molds, the method comprising:
rotating the turntable to switch the mold between the molding target mold and the standby target mold.

6. The method for molding a plurality of types of molded articles according to claim 5, further comprising:
when one type of mold selected from the other types of the molds is switched to the molding target mold, adjusting temperature of the selected one type of mold in advance.

7. The method for molding a plurality of types of molded articles according to claim 5,
wherein the upper movable plate comprises a clamper, and
wherein the method further comprises clamping and unclamping an upper mold of the molding target mold by using the clamper.

8. A method for molding a plurality of types of molded articles using an injection molding machine system, the injection molding machine system comprising:
a vertical injection molding machine comprising:
a mold clamping device configured to clamp a mold, the mold clamping device comprising:
a fixed plate;
an upper movable plate that is disposed above the fixed plate and is driven up and down with respect to the fixed plate; and
a turntable provided on the fixed plate so as to be rotatable with respect to the fixed plate, and
an injection device provided above the upper movable plate, the injection device being configured to inject an injection material;
an automatic mold warehouse configured to store a plurality of types of molds; and
a mold conveying device configured to convey the mold, the method comprising:
exchanging at least one of the molds between the vertical injection molding machine and the automatic mold warehouse by the mold conveying device; and
implementing the molding method according to claim 5 in the vertical injection molding machine.
